(19) United States
(12) Patent Application Publication
(10) Pub. No.: US 2008/0317473 A1
(43) Pub. Date: Dec. 25, 2008

(54) FREE-SPACE OPTICAL COMMUNICATION DEVICE

(76) Inventor: Akimori KUNIE, Nara (JP)

Correspondence Address: NIXON & VANDERHYE, PC, 901 NORTH GLEBE ROAD, 11TH FLOOR, ARLINGTON, VA, 22203, US

(21) Appl. No.: 12/129,249

(22) Filed: May 29, 2008

(30) Foreign Application Priority Data
Jun. 20, 2007 (JP) 2007-162782

(51) Int. Cl. H04B 10/00

(52) U.S. Cl. 398/128

(57) ABSTRACT

A free-space optical communication device includes a photodetector element, which receives a communication signal containing multiple infrared light signals respectively representing different information and converts the communication signal to an electrical signal by way of electro-optical conversion, and a signal selection unit, which receives the electrical signal from the photodetector element as input, extracts respective signals corresponding to the infrared light signals from this electrical signal, and individually outputs the electrical signal and the signals corresponding to the infrared light signals.

### BACKGROUND OF THE INVENTION

This application claims priority under 35 U.S.C. § 119(a) on Patent Application No. 2007-162782 filed in Japan on Jun. 20, 2007, the entire contents of which are herein incorporated by reference.

The present invention relates to a free-space optical communication device that is used by incorporating it with an electronic device.

As is well-known, the IrDA (Infrared Data Association) system for free-space infrared communications, which enables wireless communications between different electronic devices using infrared light signals, was standardized in 1994 based on the IrDA 1.0 and IrDA 1.1 standards. The IrDA 1.0 standard established an SIR (9.6K-115 Kbps) physical layer and the IrDA 1.1 standard defined an FIR (4 Mbps) physical layer. This made high-speed communications possible (see, for instance, JP 2005-277054A, JP 2005-318375A, etc.).

Furthermore, the IrDA communication standard-based communication protocol was simplified and the Ir-Simple protocol with increased effective communication rates was implemented, thereby allowing for small and inexpensive free-space infrared communication devices to be offered.

In communications based on such standards, there is no need to form networks and peer-to-peer (1-on-1) communication can be established in a simple manner. As a result, at present, communication devices conforming to the IrDA standard are primarily incorporated in mobile phones. Moreover, with the communication devices conforming to the IrDA standard, audio playback on miniature terminals such as the VoiceUbique™ (trademark, Nippon Telegraph and Telephone Corporation) can now be implemented as well.

However, conventional free-space optical communication devices operated in the peer-to-peer mode and transmitted only one type of information using infrared light signals. For instance, conventional free-space optical communication devices did not contemplate simultaneous reception of the respective infrared signals emitted from a plurality of electronic devices. For this reason, a need exists for further improvement in the information transmission rates of free-space optical communication devices.

### BRIEF SUMMARY OF THE INVENTION

Accordingly, the present invention was made with account taken of the above-described prior-art problems and seeks to provide a free-space optical communication device capable of receiving infrared light signals representing multiple types of information.

In order to attain the above-mentioned object, the inventive free-space optical communication device incorporated in an electronic device includes a photodetector element, which receives a plurality of light signals or a communication signal containing a plurality of light signals and subjects the received light signals to electro-optical conversion, and a signal selection unit, which receives an output signal from the photodetector element as input and extracts signals corresponding to at least one of the light signals from this output signal in a selective manner.

Moreover, in the present invention, the signal selection unit preferably switches between, and outputs, signals respectively corresponding to the light signals.

Moreover, the present invention may further include a plurality of signal processing means and the signal selection unit may be adapted to extract signals respectively corresponding to the light signals from the output signal of the photodetector element and output these signals by distributing the signals among the signal processing means.

Moreover, the signal selection unit is preferably connected to the signal processing means through signal wires and determines the signal processing means to be used as the output destinations of the signals respectively corresponding to the light signals based on the relative length of the signal wires.

Furthermore, the length of the signal wires is preferably changeable.

Moreover, the present invention may further include signal wire length detection means for detecting the length of the signal wires and the signal selection unit may determine the signal processing means to be used as the output destinations of the signals respectively corresponding to the light signals based on the relative length of the signal wires detected by the signal wire length detection means.

Moreover, the signal wire length detection means preferably detects the length of the signal wires in a mechanical or electrical fashion.

In accordance with the present invention as described above, the photodetector element receives a communication signal containing a plurality of light signals and, upon subjecting the communication signal to electro-optical conversion, outputs an output signal in the form of an electrical signal. The signal selection unit receives the output signal of the photodetector element as input and extracts signals corresponding to at least one of the light signals from this output signal in a selective manner.

Here, due to the fact that the communication signal contains a plurality of light signals, the respective light signals can be used as information transmission media, thereby permitting simultaneous communication of multiple types of information. In addition, since signals corresponding to at least one of the light signals are extracted from the output signal of the photodetector element in a selective manner, it is possible to extract only the signals that represent the necessary information.

Moreover, in accordance with the present invention, the photodetector element receives a plurality of light signals and, upon subjecting these light signals to electro-optical conversion, outputs an output signal in the form of an electrical signal. The signal selection unit receives the output signal of the photodetector element as input and extracts signals corresponding to at least one of the light signals from this output signal in a selective manner.

In this case, the use of the multiple light signals as information transmission media permits simultaneous communication of multiple types of information and the selective extraction of signals corresponding to at least one of the light signals from the output signal of the photodetector element makes it possible to extract only the signals that represent the necessary information.

Namely, in the present invention, in a situation wherein the respective light signals representing multiple types of information are communicated simultaneously, it is possible to receive all such light signals at once using the photodetector element and extract only the signals that represent the necessary information from the output signal of the photodetector element.

In other words, because signals are outputted by switching between the respective signals corresponding to the light signals, multiple types of information can be outputted in a selective manner.

Furthermore, because the respective signals corresponding to the light signals are outputted by distributing the signals among a plurality of signal processing means, multiple types of information can be allocated to the respective signal processing means.

For instance, the signal processing means to be used as the output destinations of the respective signals corresponding to the light signals are determined based on the relative length of the signal wires, thereby determining the allocation of the signals. Moreover, due to the fact that the length of the signal wires can be changed, the allocation of the respective signals can be changed by adjusting the length of the signal wires.

Furthermore, the length of the signal wires can be detected and the signal processing means to be used as the output destinations of the respective signals corresponding to the light signals can be determined based on the detected relative length of the signal wires. The length of the signal wires is detected in a mechanical or electrical fashion.

### BRIEF DESCRIPTION OF THE DRAWINGS

FIG. 1 is a block diagram illustrating Embodiment 1 of the free-space optical communication device of the present invention.

FIG. 2 is a block diagram illustrating an alternate embodiment of the free-space optical communication device of FIG. 1.

FIG. 3 is a block diagram illustrating Embodiment 2 of the free-space optical communication device of the present invention.

FIG. 4 is a block diagram illustrating Embodiment 3 of the free-space optical communication device of the present invention.

FIG. 5 is a block diagram illustrating Embodiment 4 of the free-space optical communication device of the present invention.

FIG. 6 is a block diagram illustrating Embodiment 5 of the free-space optical communication device of the present invention.

### DESCRIPTION OF THE PREFERRED EMBODIMENTS

Preferred embodiments of the free-space optical communication device according to the present invention will be described in detail below with reference to drawings.

### Embodiment 1

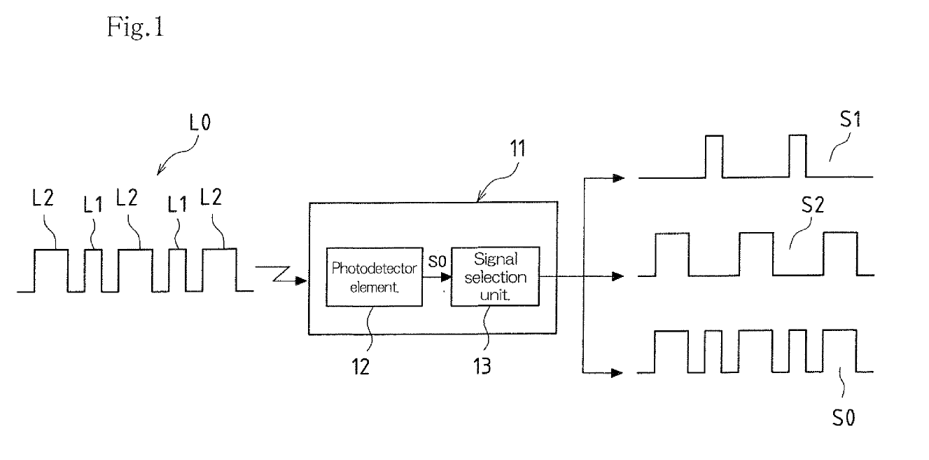

FIG. 1 is a block diagram illustrating Embodiment 1 of the free-space optical communication device of the present invention. The free-space optical communication device 11 of the present embodiment includes a photodetector element 12 and a signal selection unit 13. The photodetector element 12 receives a communication signal L0 and converts the received light signal, i.e. the communication signal L0, into an electrical signal by way of electro-optical conversion. The communication signal L0 contains two kinds of infrared light signals L1, L2, which represent different types of information.

The infrared light signals L1, L2, which may be, for instance, audio signals or music signals, are light signals that have been pulse-width modulated or pulse-density modulated in accordance with the respective mutually different types of information. These infrared light signals L1, L2 are then combined into a communication signal L0 using time division. As a result, the communication signal L0 contains the infrared light signals L1, L2 representing the respective types of information.

Moreover, the photodetector element 12 converts the communication signal L0 into an electrical signal S0 by way of electro-optical conversion and outputs this electrical signal S0. Because the electrical signal S0 is obtained by means of electro-optical conversion of the communication signal L0, it contains component signals S1 and S2 corresponding to the respective types of information represented by the infrared light signals L1, L2.

The signal selection unit 13 uses the respective timing to extract and separate the components of signals S1, S2 respectively corresponding to the infrared light signals L1, L2 from the electrical signal S0 received as input from the photodetector element 12. As a result, the signal selection unit 13 can individually output signal S1, signal S2, and the electrical signal S0.

Here, assuming that the infrared light signals L1, L2 are audio signals respectively representing the right channel audio and left channel audio of a stereo signal, the signal selection unit 13 extracts and outputs signal S1 corresponding to the right channel audio and signal S2 corresponding to the left channel audio. As a result, for instance, when the free-space optical communication device 11 of the present embodiment is incorporated in a stereo-type VoiceUbique™ (trademark) device, the right and left channel audio represented by signal S1 and signal S2 are outputted to the respective right and left earphones, thereby enabling stereo playback.

Accordingly, while in conventional peer-to-peer (1-on-1) communications it is premised that each type of information requires a receiver to be provided, the free-space optical communication device 11 of the present embodiment permits simultaneous reception of multiple types of information (e.g. audio) using a single photodetector element 12. Moreover, the configuration of the free-space optical communication device 11 of the present embodiment is thus simplified, thereby enabling further reduction in the weight and size of the devices, in which it is incorporated, and making it suitable for portable electronic devices.

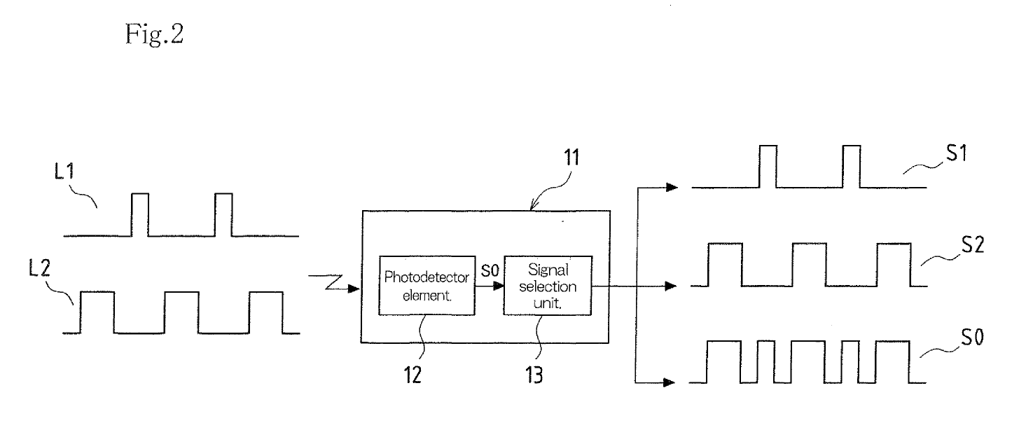

FIG. 2 is a block diagram illustrating an alternate embodiment of the free-space optical communication device 11 of Embodiment 1 described above. In the free-space optical communication device 11 of this alternate embodiment, the photodetector element 12 receives two kinds of infrared light signals L1, L2 respectively representing different information. Moreover, the photodetector element 12 subjects these received infrared light signals L1, L2 to electro-optical conversion and outputs an electrical signal S0.

Upon receiving the electrical signal S0 as input, the signal selection unit 13 separates the electrical signal S0 into signals S1 and S2, demodulates the signals, and individually outputs signal S1, signal S2, and electrical signal S0.

Here, the infrared light signals L1, L2 are light signals obtained by pulse-width modulation or pulse-density modulation and are transmitted separately. For this reason, e.g. the modulation frequencies of the infrared light signals L1, L2 can be rendered mutually different. Rendering the modulation frequencies different in this manner allows the signal selection unit 13 to separate the respective modulation frequency bands and perform demodulation to extract signal S1 and signal S2 from the electrical signal S0 produced in the photodetector element 12 by the electro-optical conversion of the infrared light signals L1, L2.

For instance, assuming that the infrared light signals L1, L2 are audio signals, with the infrared light signal L1 representing Japanese audio and infrared light signal L2 representing English audio, the respective signals S1 and S2 corresponding to the different types of audio are extracted and outputted. Moreover, if the free-space optical communication device 11 is a VoiceUbique device, then it is possible to listen to the Japanese audio represented by signal S1 or to the English audio represented by signal S2 in a selective manner.

### Embodiment 2

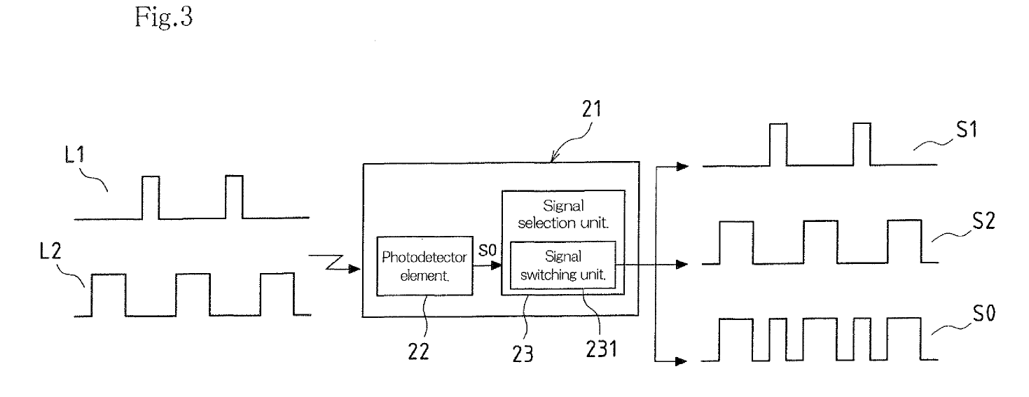

FIG. 3 is a block diagram illustrating Embodiment 2 of the free-space optical communication device of the present invention. The free-space optical communication device 21 of the present embodiment includes a photodetector element 22 and a signal selection unit 23. The photodetector element 22 receives two kinds of infrared light signals L1, L2 respectively representing different information and converts the received light signals, i.e. the infrared light signals L1, L2, into an electrical signal S0 by way of electro-optical conversion. Upon receiving the electrical signal S0 as input from the photodetector element 22, the signal selection unit 23 demodulates and separates the electrical signal S0 into signals S1 and S2 and selectively outputs them as signal S1, signal S2, and electrical signal S0.

The illustrative signal selection unit 23 includes a signal-switching unit 231. In such a case, this signal switching unit 231 can be used to select and output any signal among signals S1 and S2 corresponding to the infrared light signals L1, L2 and electrical signal S0, or output signals by switching between the signals.

Here, the infrared light signals L1, L2 are light signals obtained by pulse-width modulation or pulse-density modulation and are transmitted separately. For this reason, e.g. the modulation frequencies of the infrared light signals L1, L2 can be rendered mutually different. Rendering the modulation frequencies different in this manner allows the signal selection unit 23 to separate the respective modulation frequency bands and perform demodulation to extract signal S1 or signal S2 from the electrical signal S0 produced in the photodetector element 22 by the electro-optical conversion of the infrared light signals L1, L2.

For instance, assuming that the infrared light signals L1, L2 represent either left or right channel audio of a stereo signal, signal S1 or signal S2, which respectively corresponds to the left or right channel audio, is selectively outputted from the signal selection unit 23.

When the electrical signal S0 is selected, the electrical signal S0 is outputted to the earphones and the left and right audio is played back simultaneously. Moreover, when either signal S1 or signal S2 is selected, signal S1 or signal S2 is outputted to the earphones and the selected left or right channel audio is played back.

### Embodiment 3

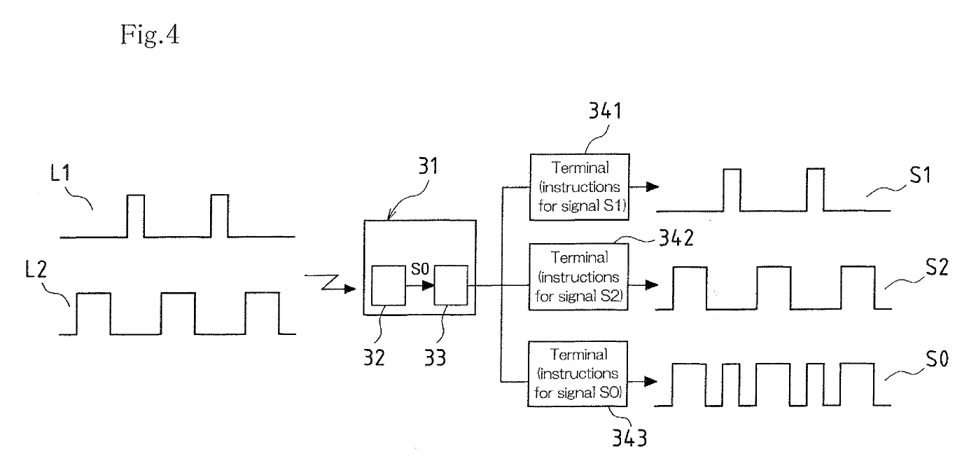

FIG. 4 is a block diagram illustrating Embodiment 3 of the free-space optical communication device of the present invention. The free-space optical communication device 31 of the present embodiment includes a photodetector element 32 and a signal selection unit 33. The photodetector element 32 receives two kinds of infrared light signals L1, L2 respectively representing different information and converts the received light signals, i.e. the infrared light signals L1, L2, into an electrical signal S0 by way of electro-optical conversion.

Upon receiving the electrical signal S0 as input from the photodetector element 32, the signal selection unit 33 demodulates and separates the electrical signal S0 into signals S1 and S2 and outputs them as signal S1, signal S2, and electrical signal S0.

The infrared light signals L1, L2 are light signals obtained by pulse-width modulation or pulse-density modulation and are transmitted separately. For this reason, e.g. the modulation frequencies of the infrared light signals L1, L2 can be rendered mutually different. Rendering the modulation frequencies etc. different in this manner allows the signal selection unit 33 to separate the respective modulation frequency bands and perform demodulation to extract signal S1 or signal S2 from the electrical signal S0 produced in the photodetector element 32 by the electro-optical conversion of the infrared light signals L1, L2.

Moreover, the free-space optical communication device 31 of the present embodiment further includes a plurality of terminals 341, 342, 343 as signal processing means, with signal S1, signal S2, and electrical signal S0 outputted by distributing them among these multiple terminals 341, 342, 343.

Each one of the terminals 342, 342, 323 includes a switch, not shown, which is used to issue switching instructions as to which signal among the electrical signal S0, signal S1, and signal S2 is to be inputted, with the switching state of these switches monitored by the signal selection unit 33.

For instance, if the switch of the terminal 341 is switched so as to issue an instruction regarding the input of signal S1, then, in response to the switching instruction of this switch, the signal selection unit 33 selects signal S1 and outputs signal S1 to the terminal 341. Moreover, if the switch of the terminal 342 is switched so as to issue an instruction regarding the input of signal S2, then signal S2 is outputted to the terminal 342 in response to the switching instruction of this switch. Furthermore, if the switch of the terminal 343 is switched so as to issue an instruction regarding the input of signal S0, then signal S0 is outputted to the terminal 343 in response to the switching instruction of this switch.

Let us suppose that the infrared light signals L1, L2 represent either one of the left- and right-channel audio of a stereo signal, with signal S1 representing the left channel audio and signal S2 representing the right channel audio. Then, in such a case, signal S1, which represents the left channel audio, will be outputted to the terminal 341, signal S2, which represents the right channel audio, will be outputted to the terminal 342, and signal S0, which represents left- and right-channel audio, will be outputted to the terminal 343.

In such a configuration, any of the multiple signals can be selectively received by a terminal simply by switching the switch on the terminal. It should be noted that the number of terminals may be increased and, in such a case, the signal selection unit 33 will be able to output the signal specified by the switching of the switch to each terminal.

### Embodiment 4

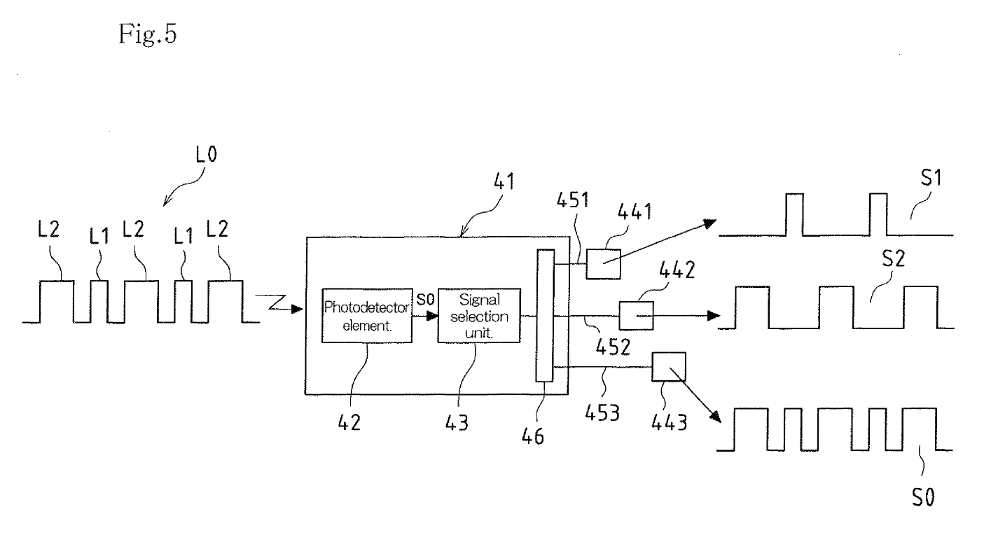

FIG. 5 is a block diagram illustrating Embodiment 4 of the free-space optical communication device of the present invention. The free-space optical communication device 41 of the present embodiment includes a photodetector element 42 and a signal selection unit 43. The photodetector element 42 receives a communication signal L0 containing two kinds of infrared light signals L1, L2 respectively representing different information and converts the received light signal, i.e. the communication signal L0, into an electrical signal S0 by way of electro-optical conversion.

For example, the infrared light signals L1, L2 are light signals obtained by pulse-width modulation or pulse-density modulation in accordance with the respective types of audio and the communication signal L0 is obtained by combining these infrared light signals L1, L2 using time division. In the photodetector element 42, the communication signal L0 is converted into an electrical signal S0 by way of electro-optical conversion.

Upon receiving the electrical signal S0 as input from the photodetector element 42, the signal selection unit 43 uses the respective timing to extract, separate, and output signals S1 and S2 respectively corresponding to the infrared light signals L1, L2 from the electrical signal S0.

Moreover, the free-space optical communication device 41 of the present embodiment further includes signal processing means and signal wire length detecting means. The signal processing means includes a plurality of terminals 441, 442, 443. The signal wire length detecting means, which includes a length detection unit 46, is connected to the signal selection unit 43.

Moreover, the length detection unit 46 and terminals 441, 442, 443 are connected, respectively, through signal wires 451, 452, 453 of different lengths. The length detection unit 46 detects the length of the signal wires 451, 452, 453 in a mechanical or electrical fashion. Signal S1, signal S2, and electrical signal S0 are distributed and outputted by the length detection unit 46 to the terminals 441, 442, 443 respectively through the signal wires 451, 452, 453.

For instance, when the terminal 441 is connected to the length detection unit 46 through the signal wire 451, a constant voltage is applied to the signal wire 451 at the terminal 441 and the amount of voltage drop across the signal wire 451 (corresponding to the resistance value of the signal wire 451) is measured at the length detection unit 46. Similarly, when the terminal 442 is connected to the length detection unit 46 through the signal wire 452, a constant voltage is applied to the signal wire 452 at the terminal 442 and the amount of voltage drop across the signal wire 452 (corresponding to the resistance value of the signal wire 452) is measured at the length detection unit 46. Moreover, when the terminal 443 is connected to the length detection unit 46 through the signal wire 453, a constant voltage is applied to the signal wire 453 at the terminal 443 and the amount of voltage drop across the signal wire 453 (corresponding to the resistance value of the signal wire 453) is measured at the length detection unit 46.

Based on this, the length detection unit 46 compares the respective amounts of voltage drop (the resistance values of the signal wires 451, 452, 453). It then determines that, for instance, the signal wire 451 is the shortest wire, the signal wire 452 is less short, and the signal wire 453 is the longest wire.

Moreover, when the electrical signal S0, signal S1, and signal S2 are inputted from the signal selection unit 43, the length detection unit 46 outputs signal S1 to the terminal 441 through the shortest signal wire 451, outputs signal S2 to the terminal 442 through the less short signal wire 452, and outputs signal S0 to the terminal 443 through the longest signal wire 453.

Let us suppose that the infrared light signals L1, L2 represent either one of the left- and right-channel audio of a stereo signal, with signal S1 representing the left channel audio and signal S2 representing the right channel audio. Then, in such a case, signal S1, which represents the left channel audio, will be outputted to the terminal 441, and signal S2, which represents the right channel audio, will be outputted to the terminal 442.

As a result, incorporating the free-space optical communication device 41 makes it possible to output left- and right-channel audio such that they are reliably distributed (for stereo playback) without using stereo jacks, etc. In addition, signal S0, which represents the right and left channel audio, can be outputted to the terminal 443 (for monaural playback).

### Embodiment 5

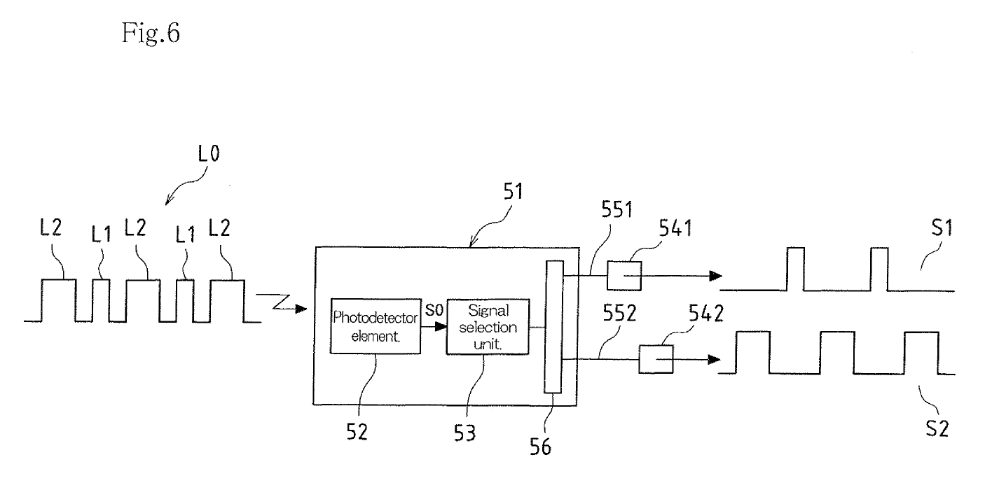

FIG. 6 is a block diagram illustrating Embodiment 5 of the free-space optical communication device of the present invention. The free-space optical communication device 51 of the present embodiment includes a photodetector element 52, a signal selection unit 53, and a length detection unit 56, The photodetector element 52 receives a communication signal L0 containing two kinds of infrared light signals L1, L2 respectively representing different information and converts the received light signal, i.e. the communication signal L0, into an electrical signal S0 by way of electro-optical conversion.

For example, the infrared light signals L1, L2 are light signals obtained by pulse-width modulation or pulse-density modulation in accordance with the respective types of audio and the communication signal L0 is obtained by combining these infrared light signals L1, L2 using time division. In the photodetector element 52, the communication signal L0 is converted into an electrical signal S0 by way of electro-optical conversion.

Upon receiving the electrical signal S0 as input from the photodetector element 52, the signal selection unit 53 uses the respective timing to extract, separate, and output signals S1 and S2 respectively corresponding to the infrared light signals L1, L2 from the electrical signal S0.

Moreover, the free-space optical communication device 51 of the present embodiment further includes signal processing means and signal wire length detecting means. The signal processing means includes a plurality of terminals 541, 542. The signal wire length detecting means, which includes a length detection unit 56, is connected to the signal selection unit 53.

Moreover, the length detection unit 56 and terminals 541, 542 are connected, respectively, through signal wires 551, 552 of different lengths. Signal S1, signal S2, and electrical signal S0 are distributed and outputted by the length detection unit 56 to the terminals 541, 542 respectively through the signal wires 551, 552.

The length of any of the signal wires 551, 552 can be changed. Moreover, the length detection unit 56 detects the length of the signal wires 551, 552 in a mechanical or electrical fashion.

For instance, the length detection unit 56 includes reels, not shown, which are used for taking up the signal wires 551, 552 of different lengths. Moreover, the length detection unit 56 can detect the angles of rotation of the reels and obtain the length of the respective signal wires 551, 552 drawn off the reels according to the angles of rotation of the reels. Based on this, the length detection unit 56 compares the lengths of the signal wires 551, 552 drawn off the reels and determines that, for instance, the signal wire 551 is shorter than the signal wire 552.

Upon receiving signal S1 or signal S2 as input from the signal selection unit 53, the length detection unit 56 outputs signal S1 to the terminal 541 through the shorter signal wire 551 and outputs signal S2 to the terminal 542 through the longer signal wire 552.

Let us suppose that the infrared light signals L1, L2 represent either one of the left- and right-channel audio of a stereo signal, with signal S1 representing the left channel audio and signal S2 representing the right channel audio. Then, in such a case, signal S1, which represents the left channel audio, will be outputted to the terminal 541, and signal S2, which represents the right channel audio, will be outputted to the terminal 542.

As a result, incorporating the free-space optical communication device 51 makes it possible to output left- and right-channel audio such that they are reliably distributed (for stereo playback) without using stereo jacks, etc. Moreover, in a situation where the respective infrared light signals L1, L2 representing a plurality of different types of information are communicated simultaneously, these infrared light signals L1, L2 can be received at once using the photodetector element 52 and only signal S1 or signal S2, which represents the necessary information, can be extracted from the output signal of the photodetector element 52.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A free-space optical communication device incorporated in an electronic device, comprising:
a photodetector element that receives a plurality of light signals or a communication signal containing a plurality of light signals and subjects the received light signals to electro-optical conversion, and
a signal selection unit that receives an output signal from the photodetector element as input and extracts signals corresponding to at least one of the light signals from this output signal in a selective manner.

2. The free-space optical communication device according to claim 1,
wherein the signal selection unit switches between signals respectively corresponding to the light signals and outputs the signals.

3. The free-space optical communication device according to claim 1, further comprising a plurality of signal processing means,
wherein the signal selection unit extracts signals respectively corresponding to the light signals from the output signal of the photodetector element and outputs these signals by distributing the signals among the signal processing means.

4. The free-space optical communication device according to claim 3,
wherein the signal selection unit is connected to the signal processing means through signal wires and determines the signal processing means to be used as the output destinations of the signals respectively corresponding to the light signals based on the relative length of the signal wires.

5. The free-space optical communication device according to claim 4,
wherein the length of the signal wires can be changed.

6. The free-space optical communication device according to claim 5, further comprising signal wire length detection means for detecting the length of the signal wires,
wherein the signal selection unit determines the signal processing means to be used as the output destinations of the signals respectively corresponding to the light signals based on the relative length of the signal wires detected by the signal wire length detection means.

7. The free-space optical communication device according to claim 6,
wherein the signal wire length detection means detects the length of the signal wires in a mechanical or electrical fashion.
